(19) United States
(12) Patent Application Publication
(10) Pub. No.: US 2015/0050988 A1
(43) Pub. Date: Feb. 19, 2015

(54) Wagering Technique Based on Projected Performance Benchmarks and Geographically Restricting....

(71) Applicants: Jason Todd Nichols, Mabank, TX (US); Kevin Wayne Sumrall, Anna, TX (US)

(72) Inventors: Jason Todd Nichols, Mabank, TX (US); Kevin Wayne Sumrall, Anna, TX (US)

(21) Appl. No.: 13/968,679

(22) Filed: Aug. 16, 2013

(51) Int. Cl. G07F 17/32; H04L 29/06

(52) U.S. Cl. CPC G07F 17/3288; H04L 63/08
USPC 463/25; 726/3

(57) ABSTRACT

Disclosed herein are systems and methods for providing access to, while in a predetermined location, information corresponding to a rules-based activity via a computer network. Access may be gained by users via the Internet or mobile networks, and may include access via a mobile device application. In exemplary embodiments, the geographic location of the user, via his computing device, is confirmed within a predetermined location for accessing and employing the system. Also disclosed are systems and methods for facilitating wagering on contests within one or more rules-based activities. In exemplary embodiments, a projected performance benchmark for a participant in a contest within the rules-based activity is established, and wagers are taken from authorized members on whether an actual performance benchmark for the participant will meet or fall below the projected performance benchmark. Winning and losing wagers are then determined based on the actual performance benchmark for the participant in the contest.

### TECHNICAL FIELD

The disclosed principles pertain, generally, to accessing private computer networks by authorized users, and more particularly to authorizing access to private computer networks and wireless mobile and computer networks related to specific events based on geographic location of users, as well as a wagering and scoring system related to such events, which may be accessed via such private networks.

### BACKGROUND

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Information concerning the geographic location of a networked entity may be useful for any number of reasons. Geographic information may be utilized by network-based content distribution systems as part of a Digital Rights Management (DRM) program or an authorization process to determine whether particular events may validly be distributed to a certain physical location. Geographic location information may also be utilized to infer demographic characteristics of a network user. Accordingly, geographic information may be utilized to direct advertisements or offer other information via a network that has a higher likelihood of being relevant to a network user at a specific geographic location. In addition, geographic location information may be utilized by network-based sweepstakes, contests, promotions, and fantasy sports games as part of an authorization process to determine whether a particular participant is eligible to participate. Finally, geographic location information may also be utilized by network-based goods or services distribution systems as part of a management program or authorization process to determine whether particular goods or services, including but not limited to promotions of such goods or services, may be validly distributed to a certain network or physical location, as well as enabling such distributor to apply factors that vary according to location, such as price or even legality of sale.

Content delivered to a specific network user on a mobile device at a known geographic location may also be customized according to the known geographic location. For example, localized news, weather, and events listings may be targeted where the geographic location of the networked mobile device is known. Furthermore, content may be presented in a local language and format. Knowing the location of a network entity can also be useful in combating fraud. For example, where a transaction is initiated at a network entity and the user is known to reside in a geographic location where the event is forbidden, the mobile device could be configured to not permit the user to participate in the event.

Generally speaking, geolocation has been implemented in a number of ways in conventional applications. For example, U.S. Pat. No. 6,629,136, entitled “System and method for providing geographically-related content over a network,” describes automatic delivery of localized information and/or services via the Internet without using information entered by a user (e.g., a ZIP code, city name). The system described in the patent obtains location information using a geocoder, such as a GPS device. The patent specifically identifies notices of local events and sports as types of localized information that can be delivered.

U.S. Pat. No. 6,665,715, entitled “Method and systems for locating geographical locations of online users,” describes a system for identifying geographical locations of on-line users and creating a database with IP addresses and corresponding geographical locations of each IP address. The location tracking system described includes a tracing engine module that sends a route identification command to all the end-users who are currently on-line. In response to the route identification command, the tracing engine module receives IP address numbers of all intermediary host computers that were employed in the route that dynamically connects the location tracking system to each of the end users. The location tracking system then obtains the geographical location of each end user that is currently on-line, based on the prior information that the user had provided.

U.S. Pat. No. 6,684,250, entitled “Method and apparatus for estimating a geographic location of a networked entity,” describes a method to estimate a geographic location associated with a network address, and includes performing a data collection operation to obtain information pertaining to a network address. The retrieved information is processed to identify a plurality of geographic locations potentially associated with the network address, and to attach a confidence factor to each of the plurality of geographic locations. An estimated geographic location is selected from the plurality of geographic locations as being a best estimate of a true geographic location of the network address, where the selection of the estimated geographic location is based upon a degree of confidence-factor weighted agreement within the plurality of geographic locations.

U.S. Pat. No. 8,213,898, entitled “System for verifying access based on a determined geographic location of a subscriber of a service provided via a computer network,” describes a system for limiting the presentation of rules-based activities based on locational data derived exclusively from the Internet Protocol (IP) address of users' networked devices. The system is comprised of a service computer configured to provide a subscription to a subscriber via a network, wherein the access is limited based on a search of a cached IP address table based on subscriber information. When the subscriber logs onto the service, the stored IP address location is compared with the current IP address, and if they match, the location is determined to be the same. Based on this derived location the subscriber is either allowed to access content online via computer network or is “blacklisted” or “blacked out” and thus prevented from viewing the rules-based activity.

Location-based games have also been employed, such as in U.S. Pat. No. 7,158,798, entitled “Location-based ad-hoc game services,” which describes a system in which a game is administered over a wireless telecommunications network using geographically defined cells. The games are offered based on an area-specific triggering event that will automatically trigger based on the location of mobile terminals. In this system the mobile terminals enter a triggering event when the number of mobile terminals has satisfied a threshold number of mobile terminals. This is communicated via short message service cell broadcasts from the base station providing communication coverage for the cell.

Although geolocation has been conventionally employed in a number of applications, there is still a need to have improved determination of the geographic location of a mobile network entity. Beyond improved location identification, there is also a need to assess and ensure compliance with conditions of use subjected to a user, or alternatively the benefits and opportunities afforded a user, of a network-based service based on the geographic location of the user, including but not limited to, regulating a user's ability to participate in various sweepstakes, contests, elections, promotions, fantasy sports games, or other interactive events related to or presented within the location of a private computer network. Additionally, there is also a need to allow users to access events which are pre-created at specific locations, without dependency a predetermined number of other mobile devices present in a given location. The systems and methods disclosed herein, and the disclosed principles in general, address such deficiencies found in previous geolocation-based applications.

### SUMMARY

Disclosed herein are systems and related methods for providing access to location specific rules-based activities based on a determined geographic location of a computing device via interaction between mobile and computer networks and authorized users' computing devices. Once access is authorized, such users may be provided with content regarding the activity and may also be afforded use of a proprietary competition or wagering system. Such wagering techniques may be based on the establishing a forecasted performance benchmark for an individual or group of individuals participating in a particular activities, such as a sporting event, and facilitating wagering on whether the specific participant(s) will exceed that forecasted performance benchmark or fall below it. Such a wagering techniques allows such benchmarks to be set for virtually any performance benchmarks for single or collections of participants, and in virtually any activity, from sporting events like football games and tennis matches, to non-sporting rules-based activities like trivia contests and elections or other voting situations.

Moreover, such access could be hosted on a mobile application of the computing device. In such embodiments, the mobile application may use location-specific data to determine which scheduled activities, or information related to such activities, is presented to the mobile application via a secure computer network, for example, via wireless telephone network or wireless computer network. More specifically, once the application determines an acceptable geolocation of the user's computing device, the user could be prompted for a location-specific and/or activity-specific access code or other security means that allows the user to participate in or interact with venue specific events. By combining geolocation information with location-specific and/or activity-specific access codes, the mobile application allows participants to eliminate any events that are not suited to their location. Such embodiments also enable the particular venue to provide pertinent advertising and/or informational material to the user via the mobile or computer network.

In one aspect, methods for providing access to, while in a predetermined geographic location, information corresponding to one or more rules-based activities via a private computer network are disclosed herein. In one exemplary embodiment, such a method may comprise providing a private computer network, which comprises one or more computing devices executing operating firmware and software, at a predetermined geographic location. Such a method also includes confirming, with one or more devices associated with the private computer network, a geographic location of a computing device, associated with a member of the private computer network, within a predetermined distance of the geographic location of the network. In addition, such a method may include authenticating, with one or more devices associated with the private computer network, access to the private computer network by the member while the computing device is within the predetermined distance. Then, such exemplary methods may include, upon successful authenticating, providing access to information regarding the one or more rules-based activities using the computing device via the private computer network only while the computing device remains within the predetermined distance.

In such exemplary methods, confirming the geographic location of the computing device may comprise employing GPS technology, Assisted GPS technology (AGPS), Differential GPS (DGPS) technology, Time of Arrival (TOA) technology, Enhanced Time of Arrival (ETOA) technology, Maximum Likelihood (ML) and Least-Square (LS) location techniques, Angle of Arrival (AOA) location technique, Received Signal Strength (RSS) localization, Signal Fingerprinting, MAC address, WiFi or LAN or telecommunications positioning system, Internet Protocol (IP) address, and RFID technology.

Also, the authenticating access may comprise authenticating an access code provided by the member via the computing device while the computing device is within the predetermined distance. In such embodiments, the access code may correspond to a specific rules-based activity among a plurality of rules-based activities, and the permitting access to information may comprise permitting access to information regarding only the specific rules-based activity.

In some embodiments, the computing device comprises a mobile computing device, in more particular embodiments, the mobile computing device comprises a mobile telephone. Moreover, the mobile computing device may include a software application configured to provide authentication data for the authenticating access. Further, software application may be configured to provide the geographic location of the computing device. In addition, in some embodiments the private computer network comprises a private wireless Local Area Network (LAN).

In exemplary embodiments, the one or more rules-based activities comprises a sporting event, wherein the predetermined geographic location comprises a location of the sporting event, and the predetermined distance comprises a venue hosting the sporting event. Also in some exemplary embodiments, the predetermined geographic location comprises a public establishment broadcasting one or more contests within the one or more rules-based activities, and wherein the predetermined distance consists of only area substantially comprising the public establishment. In some exemplary embodiments, the predetermined geographic location comprises a plurality of public establishments broadcasting one or more contests within the one or more rules-based activities, wherein the private computer network includes each of the plurality of public establishments, and wherein the predetermined distance consists of only areas substantially comprising each of the public establishments. In some exemplary embodiments, the predetermined geographic location comprises a politically independent territory, and wherein the predetermined distance consists of only area substantially comprising the politically independent territory.

Also, in some embodiments, the information regarding the one or more rules-based activities comprises data pertaining to performance of one or more participants in a contest within one of the one or more rules-based activities. For example, the one or more rules-based activities may be a sport, and wherein the data comprises a statistical performance of a team, a player, or a collection of players participating in a contest within the sport. In addition, the information regarding the one or more rules-based activities may comprise wagering information by the member on a contests within the one or more rules-based activities via the computing device while the computing device is within the predetermined distance.

In other embodiments, exemplary methods for providing access to, while in a predetermined geographic location, information corresponding to one or more rules-based activities via a private computer network are disclosed herein may comprise providing a privately accessible computer system, comprising one or more computing devices executing operating firmware and software, configured to transmit and receive information regarding one or more rules-based activities. In these embodiments, such methods may also include confirming, with one or more devices in communication with the computer system, a geographic location of a computing device, associated with a user authorized to access the computer system, within a predetermined distance of a specific geographic location stored in the computer system. In advantageous embodiments, the stored geographic location is not at the same location as the private computer system. In addition, such methods may include authenticating, with one or more devices associated with the computer system, access to the computer system by the user while the computing device is within the predetermined distance. Then, upon successful authenticating, such exemplary methods may further include transmitting and receiving the information regarding the one or more rules-based activities via the computing device only while the computing device remains within the predetermined distance.

In these exemplary methods, confirming the geographic location of the computing device may comprise employing GPS technology, Assisted GPS technology (AGPS), Differential GPS (DGPS) technology, Time of Arrival (TOA) technology, Enhanced Time of Arrival (ETOA) technology, Maximum Likelihood (ML) and Least-Square (LS) location techniques, Angle of Arrival (AOA) location technique, Received Signal Strength (RSS) localization, Signal Fingerprinting, MAC address, WiFi or LAN or telecommunications positioning system, Internet Protocol (IP) address, and RFID technology.

Also, the authenticating access may comprise authenticating an access code provided by the member via the computing device while the computing device is within the predetermined distance. In such embodiments, the access code may correspond to a specific rules-based activity among a plurality of rules-based activities, and the permitting access to information may comprise permitting access to information regarding only the specific rules-based activity.

In some embodiments, the computing device comprises a mobile computing device, in more particular embodiments, the mobile computing device comprises a mobile telephone. Moreover, the mobile computing device may include a software application configured to provide authentication data for the authenticating access. Further, software application may be configured to provide the geographic location of the computing device.

In exemplary embodiments, the one or more rules-based activities comprises a sporting event, wherein the predetermined geographic location comprises a location of the sporting event, and the predetermined distance comprises a venue hosting the sporting event. Also in some exemplary embodiments, the predetermined geographic location comprises a public establishment broadcasting one or more contests within the one or more rules-based activities, and wherein the predetermined distance consists of only area substantially comprising the public establishment. In some exemplary embodiments, the predetermined geographic location comprises a plurality of public establishments broadcasting one or more contests within the one or more rules-based activities, and wherein the predetermined distance consists of only areas substantially comprising each of the public establishments. In some exemplary embodiments, the predetermined geographic location comprises a politically independent territory, and wherein the predetermined distance consists of only area substantially comprising the politically independent territory.

Also, in some embodiments, the information regarding the one or more rules-based activities comprises data pertaining to performance of one or more participants in a contest within one of the one or more rules-based activities. For example, the one or more rules-based activities may be a sport, and wherein the data comprises a statistical performance of a team, a player, or a collection of players participating in a contest within the sport. In addition, the information regarding the one or more rules-based activities may comprise wagering information by the member on a contests within the one or more rules-based activities via the computing device while the computing device is within the predetermined distance.

In another aspect, methods for facilitating wagering on contests within one or more rules-based activities are provided herein. In one exemplary embodiment, such a method may comprise acquiring, using a privately accessible computer system comprising one or more hardware devices running operating firmware and software, information regarding at least one of a team, an individual participant, or a collection of individual participants within a rules-based activity. Such methods may also include compiling, using one or more processors associated with the computer system, the information to generate a numerical model projecting a performance benchmark for at least one of a team, an individual participant, or a collection of individual participants participating in a contest within the rules-based activity. Moreover, such methods may comprise providing, using an interface associated with the computer system, the projected performance benchmark to members authorized to access the computer system, and accepting, using the interface, wagers from the authorized members on whether an actual performance benchmark for the at least one of the team, the individual participant, or a collection of individual participants in the contest will be meet or fall below the projected performance benchmark. Then, such exemplary methods may include determining, with one or more processors associated with the computer network, winning and losing wagers based on the actual performance benchmark for the at least one of the team, the individual participant, or a collection of individual participants in the contest.

In exemplary embodiments of such a wagering method, the rules-based activity is a sport, the contest is a game within the sport, and the performance benchmark is a measurable statistical achievement during the game. In similar embodiments, the performance benchmark may be a measurable statistical achievement for an individual player during the game. In embodiments where the sport is football, the team comprises a football team, the individual participant comprises a football player, and the collection of individual participants may comprise one or more of an offensive unit, defensive unit, or special team of a football team. In certain embodiments, the projected performance benchmark pertains to a performance benchmark at a period during the contest, and wherein the actual performance benchmark is the actual performance benchmark at the conclusion of that period during the contest.

In some embodiments, the acquired information comprises measurable performance statistics of one or more of a team, an individual participant, or a collection of individual participants based on participation of the team, the individual participant, or the collection of individual participants in one or more prior contests in a rules-based activity. In related embodiments, compiling the information may comprise generating a scoring model based on assigning one or more numeric values to one or more of said measurable performance statistics. Also, the acquired information may comprise injury information regarding one or more of the at least one of the team, the individual participant, or the collection of individual participants participating in the sport. In addition, the performance benchmark may be a score total for the contest computed from a numerical model based on the compiled information.

In exemplary embodiments, the method further comprises adjusting, by the one or more processors compiling the information, the projected performance benchmark prior to the contest based at least in part on the accepted wagers. Also, the determining winning wagers further may comprise awarding scores to members having winning wagers. In some embodiments, the wagering method may further comprise determining, with the one or more processors determining winning and losing wagers, an additional amount for winning wagers based on a difference between the projected and actual performance benchmarks.

In some embodiments of the wagering technique, the interface is a computer network site associated with the computer system and accessible by the authorized members. In related embodiments, the wagering method may further comprise presenting, using the interface, to members having winning wagers an opportunity to purchase goods or services using wager winnings.

In exemplary embodiments of the wagering method, the method further comprises confirming, using hardware and software of a geographic location system in communication with the computer system, a geographic location of a member accessing the computer system. For example, the geographic location system may be selected from the group consisting of: GPS technology, Assisted GPS technology (AGPS), Differential GPS (DGPS) technology, Time of Arrival (TOA) technology, Enhanced Time of Arrival (ETOA) technology, Maximum Likelihood (ML) and Least-Square (LS) location techniques, Angle of Arrival (AOA) location technique, Received Signal Strength (RSS) localization, Signal Fingerprinting, MAC address, WiFi or LAN or telecommunications positioning system, Internet Protocol (IP) address, and RFID technology. In advantageous embodiments, the method further comprises restricting the accepting of wagers to those members within a predetermined geographic location. In some embodiments, the predetermined geographic location is an establishment presenting the contest to the authorized members. In related embodiments, the geographic location system is a location-specific access code provided by authorized members while in the establishment.

In other aspects, systems for providing access to a private computer network, as well as systems for facilitating wagering on rules-based activities, are also provided herein.

### BRIEF DESCRIPTION OF THE DRAWINGS

Exemplary embodiments of the disclosed principles are described herein with reference to the following drawings, in which like numerals identify similar components, and in which:

FIG. 1 illustrates an exemplary embodiment of a screen shot of a computer network site, such as an Internet website, that may facilitate the wagering technique disclosed herein;

FIG. 2 illustrates an exemplary embodiment of a second screen shot of a computer network site that may provide live up-to-date performance information in accordance with the wagering technique disclosed herein;

FIG. 3 illustrates a system in accordance with the disclosed principles for providing access to one or more secure sites comprising information corresponding to one or more rules-based activities at a single location displaying an event related to the activities;

FIG. 4 illustrates a system in accordance with the disclosed principles for providing access to one or more secure sites comprising information corresponding to one or more rules-based activities at multiple locations displaying one or more events related to the activities;

FIG. 5 illustrates a system in accordance with the disclosed principles for providing access to one or more secure sites comprising information corresponding to one or more rules-based activities within a politically independent geographic location;

FIG. 6 illustrates a system in accordance with the disclosed principles for providing access to one or more secure sites comprising information corresponding to a rules-based activity at a location hosting an event related to the rules-based activity;

FIGS. 7-12 illustrate a mobile device having an exemplary pages of a mobile application developed and implemented in accordance with the disclosed principles; and

FIG. 13 illustrates a functional block diagram of one embodiment of a system 1300 for facilitating wagering in accordance with the disclosed principles.

### DETAILED DESCRIPTION

The disclosed principles provide a number of innovations, including novel systems and methods for facilitating a unique wagering technique for wagering on one or more rules-based activities, such as sporting events and the like. In addition, the disclosed principles are provide systems and methods for providing access to secure event-based sites for users within a predetermined geographic location. Such secure sites may comprise a site to facilitate the disclosed novel wagering technique, but may also be sites used for any application, but accessible in the unique manner disclosed herein. A detailed discussion of the inventive wagering technique and techniques for providing access to secure sites for users within a predetermined geographic location are provided below, however, it should be understood that the embodiments described herein are only exemplary and do not limit the broader scope of the disclosed principles.

### Over/Under Wagering Technique

Generally speaking, the disclosed wagering technique facilitated by the disclosed principles involves acquiring information regarding at least one of a team, an individual participant, or a collection of individual participants participating in a rules-based activity, such as a sporting event. That information is then compiled in order to generate a model forecasting a performance benchmark for at least one of a team, an individual participant, or a collection of individual participants participating in an official contest within the activity. For example, for a football team, a numerical model may be generated forecasting a performance benchmark, such as total number of points that team will score during a particular game.

It should be noted that in many embodiments, the forecasted performance benchmark need not necessarily be the actual benchmark the individual or team is expected to meet during an event, and may instead simply be a forecasted benchmark established for the purpose of user wagering, such as to entice user wagering in a particular manner or in a particular direction. In addition, information collected and compiled may include prior performances of a team or individuals, which individuals are playing for that team during that event, how the team has historically matched up against the current opponent or teams similar to that team, the weather conditions for an event, and any more of a number of various pieces of information that may have bearing on the performance benchmark implicated. Further details regarding exemplary information used in accordance with the disclosed wagering technique are discussed below.

Once a model is built to forecast one or more performance benchmarks, the disclosed wagering technique then facilitates the accepting of wagers from users on whether an actual performance benchmark for the team, individual, or a collection of participants in the official contest will be greater or lesser than the one or more forecasted performance benchmarks. As such, the disclosed technique establishes an “over-under” for a team, individual or collection of individuals in virtually any type of rules-based activity. For example, continuing with the football example introduced above, the disclosed technique can establish an over-under for items such as the total score for a team in a particular game, total yards or score (or other performance statistic) for a player on a team, total points or yards gained or allowed by an offense or defense, or virtually any other measurable statistic of an individual, team, or other collection of individuals in a given game. Moreover, as in other types of wagering, the forecasted performance benchmark may move as the number of wagers and the amounts of those wagers continue to be accepted, or simply to influence user wagering in some manner, as mentioned above.

In exemplary applications, the disclosed principles may be implemented via one or more secure websites or other similar dedications sites accessible via a computer network. However, in other embodiments, the wagering technique disclosed herein may also be facilitated in a physical location, such as a casino or other similar establishment accessible by patrons. Furthermore, wagers may also be accepted for more than the actual results of a contest being simply over or under a forecasted over-under benchmark, such as the actual performance being a predetermined number of units over or under the forecasted benchmark. In such embodiments, various odds may be paid for each such predetermined amount of units. It should also be noted that the forecasted and actual performance benchmarks are not necessarily limited to the end of an official contest. In this respect, a performance benchmark may be forecasted for a particular time period of an official contest, such as the first or second half of a football game. Of course, any time during a contest within an activity could also be used for forecasting such performance benchmarks.

Once the official contest, such as a game within a given sport, has taken place (or a certain portion of the contest has concluded), the actual performance benchmark achieved by the specific team, player, or collection of players is determined, and the winning and losing wagers are also determined. The winning wagers may then be paid, and the losing wagers collected. Additionally, as in other types of wagering, an additional percentage, for example, 10%, may also be collected based on the losing wagers, commonly referred to as the “vig” or “juice.” Such additional fee is typically collected in most types of wagering, and allows the facilitators of such wagering to receive a fee, even if the amounts of losing wagers equals the amounts of winning wagers.

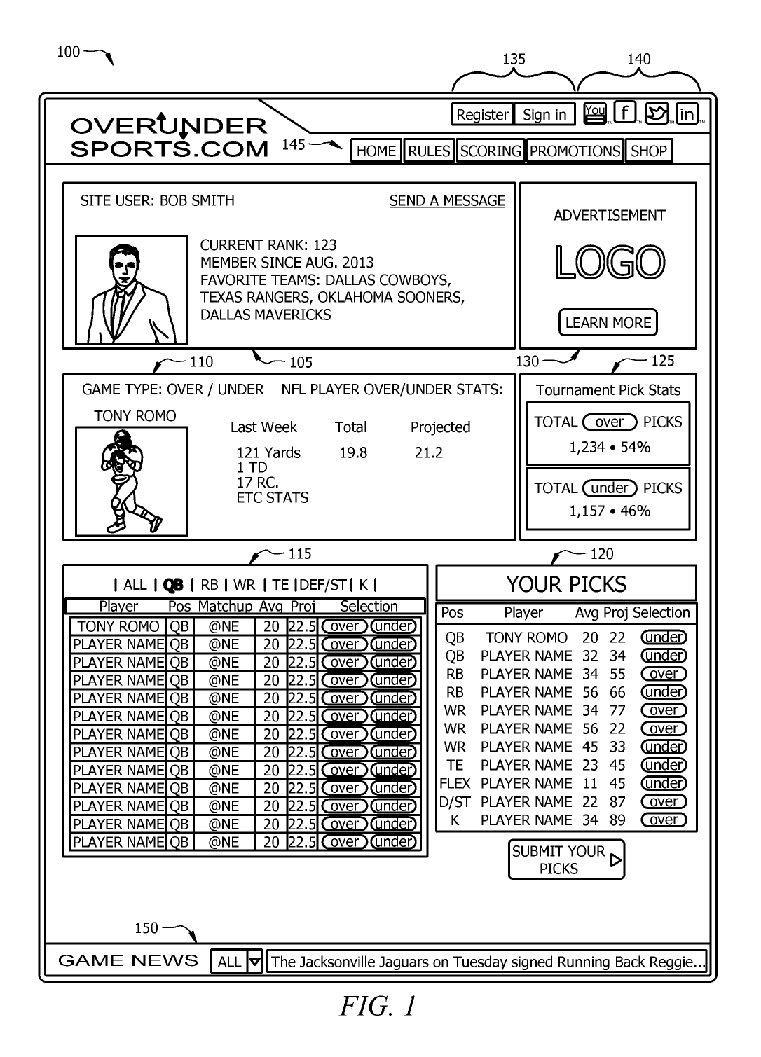

Looking first at FIG. 1, illustrated is an exemplary embodiment of a screen shot 100 of a computer network site, such as an Internet website, that may facilitate the novel wagering technique disclosed herein. The site may be hosted or otherwise provided to users of a wager technique implemented in accordance with the disclosed principles, or it may be a site hosted by a third party, such as a general gambling or other type of site, where the disclosed wagering technique is simply one or more pages within such a site. It should be noted that the screen shot 100 illustrated in FIG. 1 is merely exemplary, in both presentation and content, and thus is not intended to limit the scope of the disclosed principles.

An exemplary page can include personal information 105 about the user or subscriber of the wagering technique disclosed herein. Such information may include the user's name or handle, a photo or avatar of the user, contact information for the user, and even the user's favorites or preferences. In the embodiment illustrated in FIG. 1, the rules-based activity on which wagering as disclosed herein is facilitated, is football, and more specifically the performance of individual players of a football team. Thus, on an exemplary page may be a section 110 having information regarding a specific football player, for example, the name of the player, the team on which the player plays, the past and future opponents of that team, historical performance information of the player, and a numerical score based on one or more historical performances.

In addition, in accordance with the disclosed principles, one or more pieces of such personal and statistical information is compiled to present a forecasted or projected performance benchmark for the player in his next football game. In the illustrated embodiment, the projected performance benchmark is a collective score based on the player's overall performance in the upcoming game, e.g., “fantasy points,” however, any type of projected performance benchmark may also be provided. For example, rather than total fantasy points, only one of the player's statistics, such as passing yards or points scored, may be provided.

Further in accordance with the disclosed principles, a section 115 where the user may input wagers of select players or teams may also be provided. In the illustrated embodiment, the user may first select a particular position one or more players may play, which in this football example include quarterback, running back, wide receiver, tight end, defense/special teams, kicker, or even all positions may be selected. Once a selection is made, the user may again be presented information similar to the information provided in section 110. However, unique to the disclosed principles, the user is also presented with the option to wager whether the player will meet or exceed (“over”) or fall short of (“under”) the projected performance benchmark. As the user makes his over/under choices or “picks” on one or more of the players, collections of players, and/or teams, a separate section 120 may be provided to keep track of the user's picks. In such a section 120, details regarding the picks made may again be displayed to the user. Once a user is satisfied with his collection of over/under picks, he may click a button to finalize and submit those picks to the system.

As also illustrated in the exemplary screen shot 100 in FIG. 1, a section 125 setting forth collective information on the wagers made for all users of the system may also be provided. More specifically, the collective information may be presented with regard to a specific player, collection of players, or a team. In the illustrated embodiment, the collective information is provided on the player currently illustrated in section 110. This collective information not only informs the user how other subscribers have wagered the player will perform with regard to the selected benchmark, but may also be used to adjust the projected performance benchmark. For example, if the projected benchmark is established such that an overwhelming majority of users are wagering in only one direction, the disclosed principles may adjust the projected benchmark based on that drastically uneven distribution of wagers placed. Additionally, the collective information may be used for other adjustments as well, for example, the odds paid for a particular wager may be set higher or lower depending on whether the user bets with the majority or minority of previous wagers. Of course, the disclosed principles are broad enough to encompass any type of adjustment or other use for such collective wagering information.

Exemplary pages may further include advertisements 130, such as executable advertisement banners, around the page, and such advertisements may be used to generate revenue for the site. In specific embodiments, such advertisement may even be tailored to the specific user viewing the page, for example, based on his personal preferences or favorites. In addition, an exemplary page may include typical items as illustrated, such as buttons for registering or for registered users to login to the site 135, buttons for sharing the site or a user's picks via social media 140, and any of a number of navigation tabs 145 for users to navigate the site. Still further, news updates regarding the specific rules-based activity on which wagering may occur, or perhaps individuals, collections of individuals, or teams within such activity, may also be provided in an update section 150 of the page. Of course, different or additional sections, buttons, and/or tabs may also be included in exemplary pages found on a site created and hosted in accordance with the disclosed principles.

Looking specifically at the wagering technique provided by the disclosed principles, in a specific example involving a user wagering on football players, for example, using the exemplary page illustrated in FIG. 1, during the process the user's sets his “line-up,” a player is available only until his game is started. The moment his game starts, then his profile or record is locked and he is no longer available for line-up.

As discussed above, each player will be given a projected or forecasted score on which the user can make his bet. For this, for each player in the user's selected line-up, the user selects “over” or “under” with respect to the projected score for each player. If the user picks “over” for a player, the user is wagering that the participant in a contest within a rules-based activity will perform over the projected score or point total based on the calculation or conversion of the contest or rules-based activity statistics to a scoring system established in accordance with the disclosed principles. Alternatively, the user may select “under” for a player, meaning the user is wagering that the player will not exceed the forecasted score or point total for the particular contest or event with the activity on which he is wagering. Importantly, this aspect of the disclosed principles allows a user to still win his wager when a player, collection of players, or a team in his line-up underperforms, as opposed to conventional fantasy football scoring where users only win if their selected player, collection of players, or team performs well.

In the illustrated embodiment, the player is projected to attain 21.2 “fantasy point,” which in this example may be calculated using a pre-established fantasy football scoring system. Thus, based on the user's familiarity with the player's abilities and his history, as well as any of a number of other factors regarding past games or the upcoming game, he wagers whether he believes the player will meet or fall short of that forecasted score. This will be the same for all players, collection of players, or teams on which the user chooses to wager. In this respect, depending on the particular embodiment, participating users may be required to select only a certain number of players, etc. for his line-up. Alternatively, again depending on the implementation, users may be allowed to submit as many wagers as they desire, any without limitation to a certain number of players, etc.

In a more specific example, as in a typical fantasy football situation, a user may be required to select a predetermined number of positions, as well as number of players or collection of players, at certain positions. For example, each user may be required to select no more and no less than a single quarterback, two running backs, one tight end, two wide receivers, one kicker and one defense/special teams unit. For each of the selected players or collections of players (i.e., defense/special teams unit), each user then select “over” or “under” based on his/her evaluation of the projected performance benchmark for each player/unit each user has selected for his/her fantasy team. In this example, both the projected and actual performance benchmarks may be scored using a conventional fantasy point scoring system; however, any type of scoring system may also be employed. Once the footballs games are under way, scoring, by whatever means employed, is calculated for each users' team of selected players/units. Specifically, for each correct “over” or “under” selected by a user, that user may be awarded a certain amount of points. Incorrect such wagers may be awarded no points.

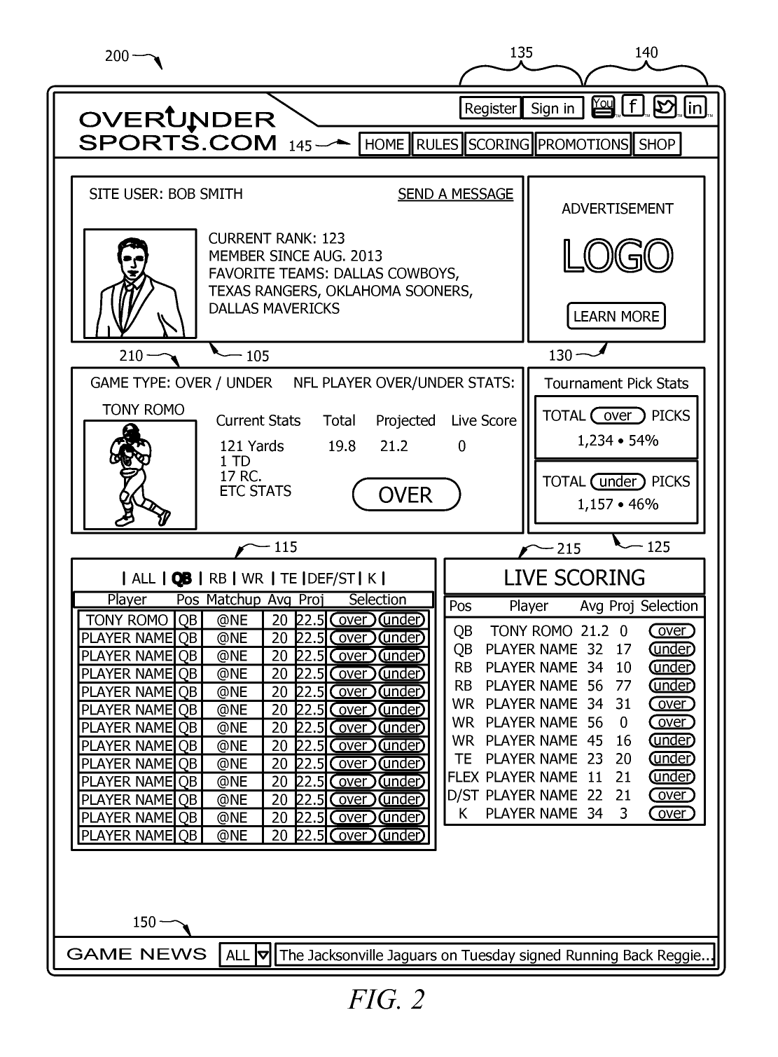

In addition, for each winning selection per player/unit, users may be awarded bonus points based on the extent by which the player/unit actual performance benchmark was over or under the projected benchmark. For example, in addition to wagering correctly that a player, collection of players, or team met the projected score, users may be rewarded “bonus points” based on the difference between the projected point total and the actual point total. For example if the scoring system projected 21.2 converted points for a participant in a rules-based activity and the participant actually achieves 24.7, and the user correctly wagers “over,” the scoring system in accordance with the disclosed principles may award to the user a given amount for his winning “over” wager, as well as bonus points, for example, in the amount of points the player, collection of players, or team exceeded the projected score. In this example, since the player achieved 24.7 points (by whatever measure of performance is used for the scoring model in the particular application), a user in this fantasy football example may be awarded the 24.7 points achieved by the player, plus 3.5 in bonus points based on the margin above the projected score. Alternatively, the user may be given a flat amount of points for wagering correctly “over” the projected score, and then also bonus points for the margin over the projected score. The same exemplary results may occur if the user bets “under” the projected score, and the player, collection of players, or team fails to meet that projected score. Of course, any type of scoring based on the disclosed over-under wagering technique may be employed, each of which is within the broad scope of the disclosed principles. Furthermore, on a page like the page illustrated in FIG. 1, as a player, collection of players, or team accumulates actual points during a game, user may see the difference between the actual points and the projection in a live scoring presentation, which is discuss in detail below with reference to FIG. 2.

When all of the scoring is tallied for a user's fantasy team, the user may then be displayed a total score for his team, and that score may be gauged against other users, for example, in a predetermined league including that user, or perhaps a larger group of users, such as all the user in particular venue, or even all the users nationwide, regardless of location. Thus, the disclosed unique wagering technique allows users to wager on players/units/teams individually, or to build a “fantasy” team with a certain selection of players/units/teams, without regard to whether a particular player/unit/team has already been selected by another user. Such an approach greatly expands not only the selections available to all users, but also results in no limits being placed on the number of users that may wager on a particular player/unit/team as well as the number of users that may compete in a given wagering event or activity. Moreover, while this particular example involves fantasy football, any type of fantasy sports betting, or even non-sports related betting on any event within a rules-based activity, benefits from the advantages of the disclosed principles.

Moreover, in this example, the projected score used in totaling fantasy points for the football player/unit/team during the upcoming single game, however, another advantageous feature of a system or method established in accordance with the disclosed principles is that any type of projected performance benchmark may be used. For example, rather than projecting the total fantasy points in the upcoming game, the projection and wager may be based on the player's performance in only a quarter or a half of the game. Also, the projection may be based on only a particular statistic during the game, such as the number of touchdown passes, the number of yards thrown, the number of completions, the number of yards rushed, completion percentage, quarterback rating, or any other statistic that can be measured during the player's participation in the event within the rules-based activity.

This flexibility of a system or method according to the disclosed principles provides numerous benefits over conventional wagering techniques. For example, wagering is not limited to a single score, such as total fantasy points, and instead wagering can be made on any measurable statistic during a contest within a rules-based activity. Also, wagering is not limited to only certain players, teams or collection of players within a particular contest or event. More specifically, in conventional “fantasy sports” wagering systems, once a player, collection of players, or a team is selected by one user within a given league, other users within that league are not permitted to place wagers on the same player, collection of players, or team. But with the disclosed technique, any player, collection of players, or team can be wagered upon by all participants, without limitation, since each player, collection of players, or team is given one or more projected performance benchmarks, and each user simply bets on whether the player, collection of players, or team will meet or fall short of that projection. Moreover, any type of rules-based activity can be made the subject of wagering with in the disclosed technique. While the present example is discussed in terms of football players, collections of players, or teams, any other sport having players, collections of players, or team may also be wagering upon using the disclosed principles. Still further, while sports betting tends to be the most common form of wagering in the world, the disclosed wagering technique is not limited to sports, and may be extended into any rules-based activity or event that has a measurable performance benchmark. Examples can include elections, where users wager on the performance of a given candidate, or perhaps how certain demographics or geographic areas may vote on a candidate or issue.

Furthermore, the disclosed wagering technique may be extended beyond a single “league” of users, and can instead be as large a group of users as desired, and perhaps directed to only one or more specific contests/events within a rules-based activity. For example, in embodiments discussed below in further detail, the disclosed wagering technique may be implemented on one or contests, within one or more rules-based activities in a given location. Specifically, user may be the patrons within a restaurant or bar, or chain of restaurants or bars, having televisions broadcasting the contests. Similarly, users may include some or all of the attendees of an event, such as a stadium hosting the event. Thus, the disclosed wagering technique is not limited to any number of users or leagues since any number of users can be given the opportunity to place over-under wagers on any measurable performance benchmark for any individual, collection of individuals, or team, in any type of rules-based activity, in any number of event or events, and in any geographic location.

Turning now to FIG. 2, illustrated is an exemplary embodiment of another screen shot 200 of a computer network site, such as an Internet website, that may facilitate the novel wagering technique disclosed herein. The page providing this screen shot 200 differs from the page discussed with respect to FIG. 1 in that “Live Scoring” is provided. More specifically, much of the sections and information provided to the user in the prior page may also be provided in this page. Repeating such information allows user to better follow what they have previously wagered on. In addition, however, the live scoring information provides users with up-to-date information on the actual performances of the individual, collection of individuals, and teams involved in the particular rules-based activity.

Continuing with the football example discussed with respect to the screen shot 100 in FIG. 1, section 210 of the screen shot 200 in FIG. 2 may provide similar information on a particular player on which the user placed an over/under wager in accordance with the disclosed principles. For example, the projected performance benchmark may again be displayed, along with the over/under wager placed by the user. However, now the illustrated information may be augmented with data regarding the player's current performance in a game. For example, rather than historical performance statistics like passing yards and touchdown passes, such a section 210 may provide the player's current passing yards and touchdown passes. Additionally, the numerical value of the player's current actual performance may also be displayed. As such, the “live scoring” providing actual current data of performance benchmarks on which a user has placed his over/under benchmarks not only gives the user up-to-date information on how he is faring on the wagers he has placed, but also adds an element of excitement and suspense for the user as the game is progressing.

In addition to providing up-to-date data on an individual player or team, a site in accordance with the disclosed principles may also include a section 215 comprising “live scoring” information on all of the user's wagers placed with the site. Such a section 215 may again provide the user information on the particular players/teams he has wagered on, and what over/under wagers he actually placed, yet may also provide the user with the current progress towards each one's performance benchmark in a single, easy-to-read area of the page. As before, different or additional information about such wagers placed by the user may also be provided in such a collective live scoring section 215.

The exemplary embodiments of discussed with respect to FIGS. 1 and 2 relate to a website hosted by a provider of the disclosed wagering systems and methods, and thus may be accessed via a computer network, such as the Internet. Thus, users of such a site may access the computer network by any means available to them. For example, users may access the site using hardwired connections, such as a computer connected via a modem and an Internet service provider, or via wireless telephone networks or a wireless computer network (e.g., WiFi). Moreover, users may access the site via a mobile application or other dedicated software installed on their mobile computing device, such as a telephone, tablet computer, or notebook computer. Of course, the disclosed principles are broad enough to encompass any means for users to access a site constructed for providing the disclosed wager technique, either now existing or later developed.

Moreover, as mentioned above, the novel over/under wagering technique disclosed herein may be implemented in an almost infinite number of applications. While the above exemplary embodiments discuss implementing the disclosed wagering technique with respect to football, the disclosed over/under wagering technique may also be implemented in other sporting activities. Other exemplary implementations include online sweepstakes, contests or promotions, political elections, or any other rules-based activity on which a projected performance benchmark may be calculated and the actual performance of an individual, collection of individuals, or a team in that activity can be measured.

### Geographical Exemplary Embodiments

In order for users to participate in or interact in some manner with a rules-based event or activity, the user, or more accurately, the user's mobile computing device, may be required to be located within a predetermined distance of a geographic location having a computer network facilitating access to a site, such as an exemplary wagering site in accordance with the disclosed principles, related to the rules-based activity. As used herein, such a site is “related to” a rules-based activity in that it may facilitate users to participate in, place wagers on in some respect, or simply receive information about, the rules-based activity, while within the predetermined distance of the location. However, in these embodiments, the disclosed principles involve providing access to such a site when the user's computing device is within a predetermined distance of a geographic location. The location may be, for example, a restaurant or bar offering the event for viewing, a collection of such establishments, or could be the actual location of the event, such as a sports stadium. Also, the location could be a wagering facility, such as a casino, or the location could be as large as an entire city, state, nation, or other politically independent territory.

Thus, generally speaking, exemplary embodiments include systems that can include a mobile application on a user's mobile device physically located within a predetermined distance surrounding a specific geographic location, or direct connection by a user via his computing device, whether mobile or not. A service computer, e.g., running at a specific location or across a computer network as discussed above, may provide entry to the user, via a mobile application or direct connection of the user's computing device, via a network where such entry is still limited based on the geographic location of the computing device. The interface of the service computer in such exemplary systems may be further configured to receive access information as the participant is accessing a site hosted by the service computer, or a computing device associated with the service computer, and the mobile application may communicate access information, including geographic location and an access code or other unique identifier. The service computer verifies access by the user based on the geographic location of the user's computing device and the specific access code entered by the user. Depending on the desired application, any type of location technologies or techniques, either now existing or later developed, may be employed to confirm the geographic location of the user's computing device. These include, but are not limited to GPS-based technology, computer network technologies, and cellular telephone network technology. More specifically, exemplary location technologies and techniques employable in accordance with the disclosed principles include GPS technology, Assisted GPS technology (AGPS), Differential GPS (DGPS) technology, Time of Arrival (TOA) technology, Enhanced Time of Arrival (ETOA) technology, Maximum Likelihood (ML) and Least-Square (LS) location techniques, Angle of Arrival (AOA) location technique, Received Signal Strength (RSS) localization, Signal Fingerprinting, MAC address, WiFi or other wireless computer/telecommunications technology location systems, Internet Protocol (IP) address, and RFID technology.

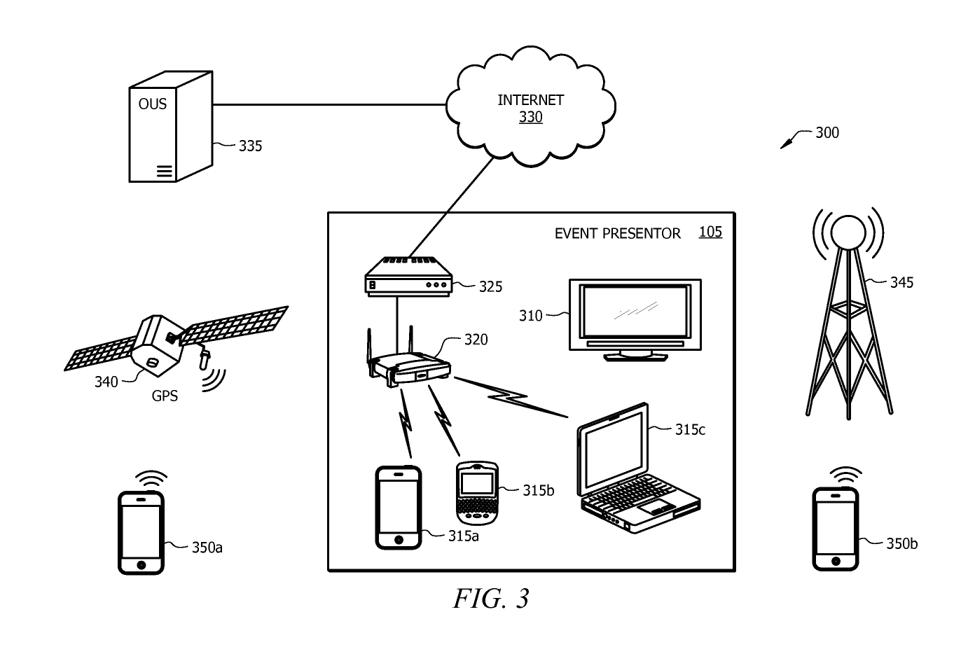

Looking at FIG. 3, illustrated is a system 300 for providing access to a secure site comprising information corresponding to one or more rules-based activities while at a single location displaying an event related to the activities. More specifically, the system 300 includes an event presenter 305 that presents an event within the rules-based activity for display to its patrons. For example, the event presenter 305 may be a restaurant or bar having televisions 310 for presenting the event to its patrons. In such embodiments, the event may be a sporting event, but any type of rules-based event may be presented.

Within the event presenter 305 may be one or more patrons, each with a computing device, 315a, 315b, 315c. These devices 315a-c may be mobile telephones, personal data assistants (PDAs), tablet computers, notebook computers, or any other type of computing device. While within the event presenter 305, the computing devices 315a-c may communicate with a wireless communications device 320, such as a wireless router. The wireless router 320 may be connected to a device 325 configured to connect to one or more servers via a computer network, such as the Internet 330. Such computing device 325 may be a modem, a server, or any other type of computing device configured to facilitate such a network connection. Moreover, the event presenter 305 may also provide hardwire connections to patrons via the modem 325. Thus, by providing the ability for patrons' computing devices 315a-c to connect to a computer network via wireless or hardwired connections, the event presenter 305 has established a local area network (LAN) for its patrons.

Alternatively, regardless if a LAN is provided or not, patrons may directly connect their computing devices 315a-c to a computer network 330 via a wireless telephone network. In such embodiments, the computing devices 315a-c may connect using a voice network or a data network, such as through a telecommunications server (not illustrated). Of course, other means of connecting a computing device 315a-c may also be used and all such means of connection, either now existing or later developed, are all within the scope of the disclosed principles.

Connection via the LAN of the event presenter 305 or via another network connection means facilitates access to one or more secure sites via the Internet 330 or other computer network. Such secure sites may be hosted by a server across the computer network 330, and may be related to facilitating wagering one or more rules-based activities that may occur at any location around the world. For example, the secure sites may facilitate wagering on one or more of the rules-based events, such as a sporting event, in the exemplary manner discussed above. In addition, the secure site(s) may provide information specifically related to one of the rules-based events, and each type of rules-based activity may have its own dedicated secure site accessible by users in the manner discussed in the exemplary embodiments above.

In order to gain access to one or more secure sites via the computer network 330, the disclosed principles include the determination of the geographic location of the computing devices 315a-c associated with patrons authorized to access one or more secure sites associated with the rules-based activities. In one embodiment, the geographic location of one or more of the computing devices 315a-c may be provided or confirmed using GPS satellite location techniques. More specifically, one or more GPS satellites 340 may be used in conjunction with GPS-based hardware/software in one or more of the computing devices 315a-c to determine the location of such device(s) 315a-c within a predetermined distance of the event presenter 305, such as the grounds inside and immediately surrounding the location of the event presenter 305. Alternatively, the geographic location of one or more of the computing devices 315a-c may be provided or confirmed using one or more cellular towers 345. In such embodiments, mobile device geographic location is determined by a mobile telecommunications network via, for example, the location of the cell tower (i.e., the actual node on a cell tower servicing the mobile device) which is updated by the mobile device when it changes from one cell tower to another.

Still further, one or more of the computing devices 315a-c may comprise an application loaded thereon that facilitates the determination of the geographic location of the computing device having the application. Moreover, such an application may be specifically associated with or developed by the provider of the one or more secure sites. Discussion of such an application is provided in greater detail below. In yet other embodiments, the local area network may simply detect when the mobile device is within a predetermined distance proximate the venue location having the network. In these embodiments, a mobile application, such as an application similar to the application just discussed, may provide the location of the mobile device by pinging via the local network. Alternatively, rather than an application, a mobile device may include hardware or software, such as RFID technology, that is detected by equipment within the event presenter 305 while the device is within the predetermined distance. Other possible location technologies or techniques, whether specifically in a mobile device application or not, may include GPS technology, Assisted GPS technology (AGPS), Differential GPS (DGPS) technology, Time of Arrival (TOA) technology, Enhanced Time of Arrival (ETOA) technology, Maximum Likelihood (ML) and Least-Square (LS) location techniques, Angle of Arrival (AOA) location technique, Received Signal Strength (RSS) localization, Signal Fingerprinting, MAC address, WiFi or other wireless computer/telecommunications technology location systems, Internet Protocol (IP) address, and RFID technology. Of course, these techniques for location determination are simply exemplary, and thus the disclosed principles are broad enough to encompass any computing device location technique, either now existing or later developed.

Regardless of the technique used to confirm the geographic location of a user's computing device, even if one or more computing devices 350a, 350b are equipped with GPS-based or cellular tower-based location technology, or any other geolocation technology, once these devices 350a-b are determined to not be within the predetermined distance of the event presenter 305, these devices would not be permitted to access the secure site associated with the rules-based activity. This would be the case, even if these devices 350a-b were capable of receiving a signal of the event presenter's LAN or could access the computer network 330 by any other means. Thus, by confirming the geographic location of patrons, access to such sites can be limited to only those patrons within the predetermined distance of the geographic location of the event presenter 305.

In addition to determining or confirming the geographic location of the computing devices 315a-c associated with patrons of the event presenter 305, access to the secure site may also require the use of a unique identifier by the patron attempting to access the secure site. In one embodiment, an access code may be provided by the event presenter 305 so that one or more of its patrons may access the secure site associated with the rules-based activity (in addition to confirmation of their geographic location, as discussed above). Such an access code may be the same for all patrons wishing to access the secure site. Additionally, if more than one secure site, each associated with one or more rules-based activities, is accessible while at the event presenter 305, a separate access code for each such secure site may be available. For example, if the rules-based activities are sporting events, such as a collection of football games and a collection of baseball games, and secure sites are separate sites related to either football or baseball, then separate access codes for each such site may be provided.

Alternatively, an access code or other unique identifier may be unique to each user of such a secure site. In such embodiments, users may be members of an organization that hosts the secure site(s) related to the rules-based events. As such, users may have subscriptions to access one or more such sites, and such access is tied to each user's unique identifier. Thus, when a user provides his unique identifier while at a given event presenter 305, his access to select secure sites is granted in accordance with his subscription. In the example discussed above, if a particular user's subscription is limited to football-related activities, then he may be given access to only the secure football-related site, or a football area of a larger site, once his geographic location is confirmed.

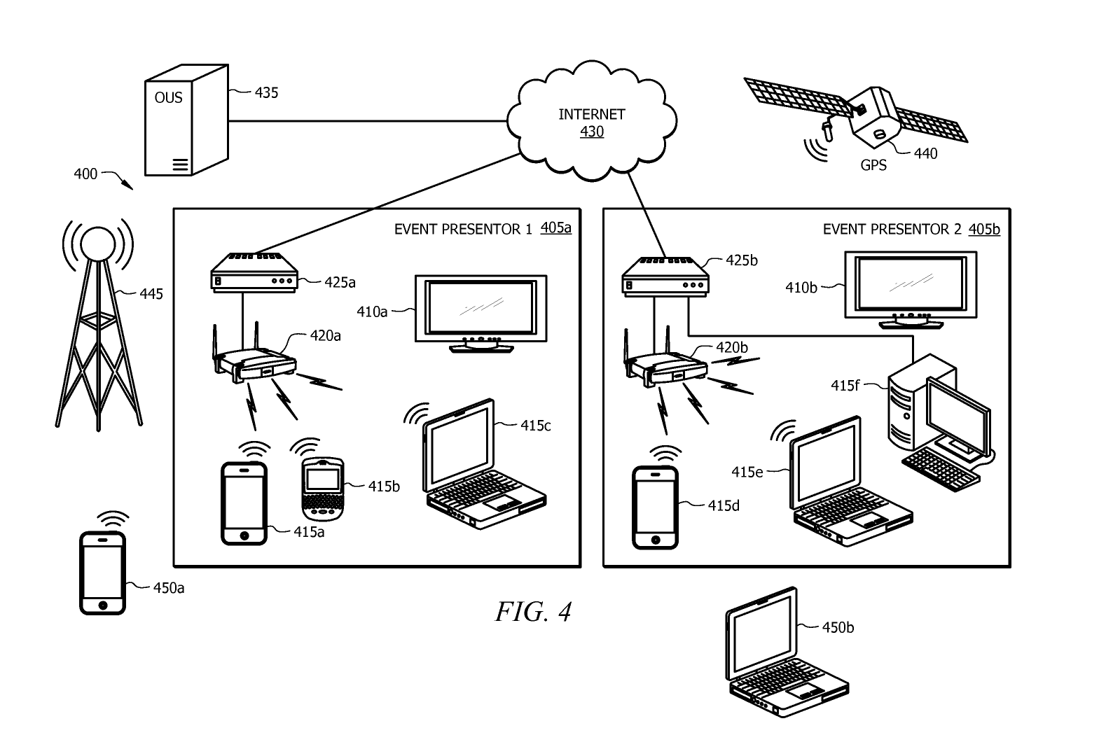

Turning now to FIG. 4, illustrated is an exemplary embodiment of a system 400 for providing access to one or more secure sites comprising information corresponding to one or more rules-based activities at multiple locations displaying one or more events related to the activities. The exemplary system 400 includes first and second event presenters 405a, 405b that present one or more contests or events related to one or more rules-based activities for display to its patrons. In accordance with this embodiment, the event presenters 405a-b are related to one another, for example, separate locations of a chain of restaurants or bars having televisions for presenting events to its patrons. As before, each event presenter 405a-b may have one or more televisions 410a, 410b in order to display the rules-based activities to patrons.

The patrons within each event presenter 405a-b each have a computing device, 415a, 415b, 415c and 415d, 415e, 415f. These devices 415a-f again may be mobile telephones, personal data assistants (PDAs), tablet computers, notebook computers, or any other type of computing device. As before, the computing devices 415a-f may communicate with a wireless communications device 420a, 420b, such as a wireless router, which is connected to a modem 425a, 425b or other device configured to connect to a computer network, such as the Internet 430. Alternatively, rather than connecting via each event presenter's LAN, patrons can connect directly to the computer network through other means, such as a cellular communications network, a hardwire connection, or other connection means. Once patrons' devices 415a-f are connected to the computer network 430 by whatever means employed, patrons may access one or more secure sites that are again hosted by a server across the computer network 430, and are related to one or more rules-based activities that may be occurring at any location around the world. Specific embodiments of such secure sites in accordance with the disclosed principles may be in accordance with the exemplary sites discussed above that may facilitate wagering on rules-based events.

In order to gain access to one or more such sites via the computer network 430, the disclosed principles again include the determination of the geographic location of the computing devices 415a-f associated with patrons authorized to access such sites associated with the rules-based activities. As before, the geographic location of one or more of the computing devices 415a-f may be provided or confirmed using any type of geolocation technique. For example, GPS satellite location techniques employing one or more GPS satellites 440 may be used in conjunction with GPS-based hardware/software in one or more of the computing devices 415a-f to determine the location of such devices 415a-f within a predetermined distance of the corresponding event presenter 405a-b. Alternatively, the geographic location of one or more of the computing devices 415a-f may be provided or confirmed using one or more cellular towers 445, as described above. Furthermore, applications on the computing devices 415a-f may facilitate the determination of geographic location, the local area network may detect when a mobile device is within a predetermined distance of the network, and RFID technology are all exemplary options for geolocation of user's devices 415a-f. As before, for computing devices 450a, 450b determined to not be within the predetermined distance of one of the event presenters 405a-b, the disclosed principles would prevent these devices 450a-b from gaining access a secure site associated with a rules-based activity even if these devices 450a-b obtained a connection to the computer network 430. Consequently, access to these secure sites is limited to only those patrons within the predetermined distance of the geographic location of one of the event presenters 405a-b.

Also in accordance with the disclosed principles and as discussed above in detail, once the geographic location of patrons' computing devices 415a-f is confirmed to be within the predetermined distance of the location of one of the event presenters 405a-b, access to the secure site(s) may again require the use of a unique identifier by patrons attempting to access a secure site. The access code(s) may again be provided by the event presenters 405a-b, and a separate access code be required for each event presenter 405a-b. Alternatively, access codes may be provided by the host 435 of the secure site(s), and those codes may be based on each user's subscription with the host 435. Thus, when a user provides his unique identifier while at a given event presenter 405a-b, his access to select secure sites is granted in accordance with his subscription. Moreover, unique identifiers may also, or alternatively, be specific to the type of rules-based activity related to a secure site being accessed.

Also, in embodiments involving single or multiple locations, such as the exemplary embodiments of FIGS. 3 and 4, users of the disclosed systems and methods may be situated to compete against one another. As such, the disclosed principles may provide a wagering system, or simply access to one or more sites having the wagering system, that allows these users to not only wager on rules-based events, but to compete against other users at that single location. Thus, an access code to the system provided as disclosed herein may be specific to a given geographic location, as discussed above, to ensure users are only competing against other users at that same location. In embodiments having multiple locations, such as a chain of restaurants or bars, the collection of participating users at each location may compete against the collection of users at another location. In such an example, access codes may be unique to each location to identify which users are at which location. Alternatively, users at any location of the collection of restaurants or bars may compete among each other, regardless of location, within the same competition. In this respect, the competition would be limited to patrons of any of the chain of establishments, regardless of which location, so long as the participating users are within the particular chain of establishments.

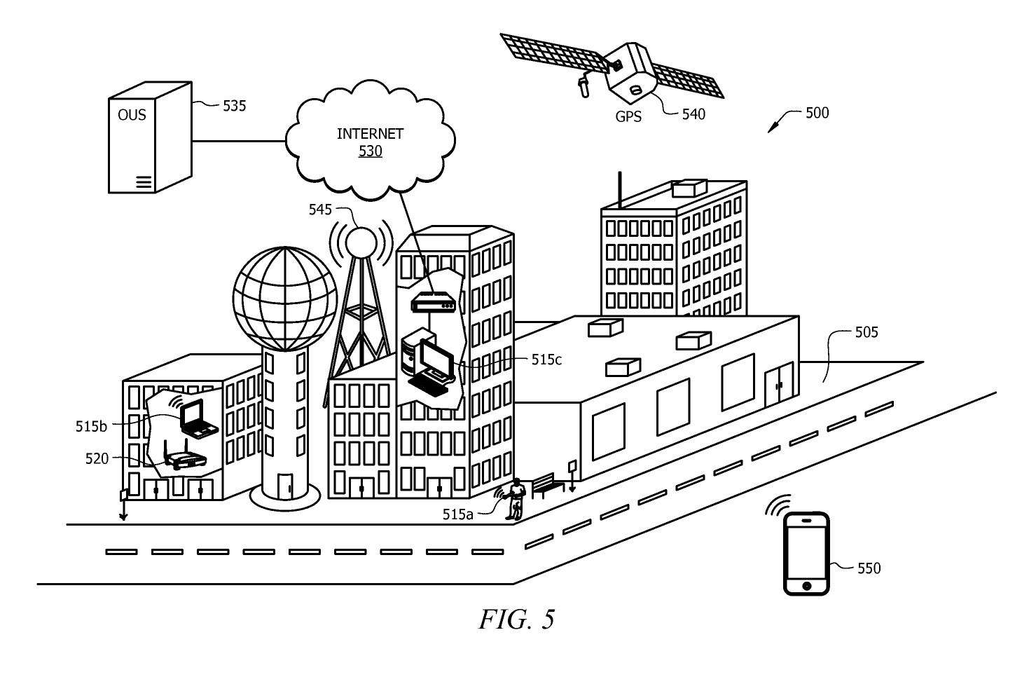

Turning now to FIG. 5, illustrated is an exemplary embodiment of a system 500 for providing access to one or more secure sites, which again may facilitate wagering with regard to one or more rules-based activities, where access is limited to a particular politically independent territory. Specifically, in the illustrated embodiment, the politically independent territory is a city 505; however, in other embodiments, the politically independent territory may be only a part of a city, such as a voting district, or may be an entire state or even a nation. In such embodiments, the disclosed principles may be used in accordance with a rule-based activity like a political election or voting on an issue that is limited to the jurisdiction comprising the geographic location.

In the embodiment of FIG. 5, residents within the geographic confines of the city 505 have computing devices 515a, 515b, 515c, which are configurable to access one or more secure sites provided and maintained by a host 535. As discussed above, the one or more secure sites may be sites that facilitate wagering on events/contests related to rules-based activities, such as the exemplary embodiments discussed above. Also as in other embodiments of the disclosed principles discussed above, the geographic location of these computing devices 515a-c may be determined by any geolocation means, either now existing or later developed. For example, one or more GPS satellites 540 may be used in conjunction with GPS hardware/software on the computing devices 515a-c to determine with geographic location of one or more of the devices 515a-c. Alternatively, the geographic location of one or more of the computing devices 515a-c may be provided or confirmed using one or more cellular towers 545, as described above. Furthermore, applications on the computing devices 515a-c may facilitate the determination of geographic location, a local wireless network may detect when the mobile device is within a predetermined distance of such a wireless network, and RFID technology are all exemplary options for geolocation of user's devices 515a-c. As before, for computing devices 550 determined to not be within the predetermined distance of the established geographic limits of the city 505, the disclosed principles would prevent these devices 550 from gaining access to a secure site associated with a rules-based activity even if these devices 550 obtained a connection to the computer network 530.

In accordance with the exemplary embodiment of FIG. 5, the one or more secure sites provide users of the computing devices 515a-c determined to be within the predetermined distance of the established geographic boundaries of the city 505 access to participate in, interact with, or receive information about one or more rules-based activities. More specifically, if the rules-based event is an election or other type of ballot-based vote for residents, the disclosed principles provide for qualified residents to participate in such a vote via the secure site(s) using their computing device, while they are located within the predetermined distance of the city 505. Such users of the computing devices 515a-c may access the secure site(s) through any means, such as wireless LAN via a wireless router 520, a cellular communications or data network via a cell tower 545, or even a hardwire connection to modem or other similar device configured to facilitate access to a computer network, such as the Internet 530. However, as disclosed herein, even if a user of a computing device 505a-c has an access code or similar means for accessing a secure site related to the rules-based activity, access will not be permitted unless that user's device 505 is within the predetermined distance of the geographic location of the city 505.

As before, once the geographic location of users' computing devices 515a-c is confirmed to be within the predetermined distance of the city 505, access to the secure site(s) may require the use of a unique identifier by users attempting to access a secure site. Example of such unique identifier could be users' voter identification number, social security number, or any other type of unique number or code assigned to or selected by a user. The access code(s) may be provided to users by any of a number of means, such as by the city 505 itself. Alternatively, access codes may be provided by the host 535 of the secure site(s), and those codes may again be based on each user's subscription with the host 535, and thus access to each user is granted in accordance with his subscription.

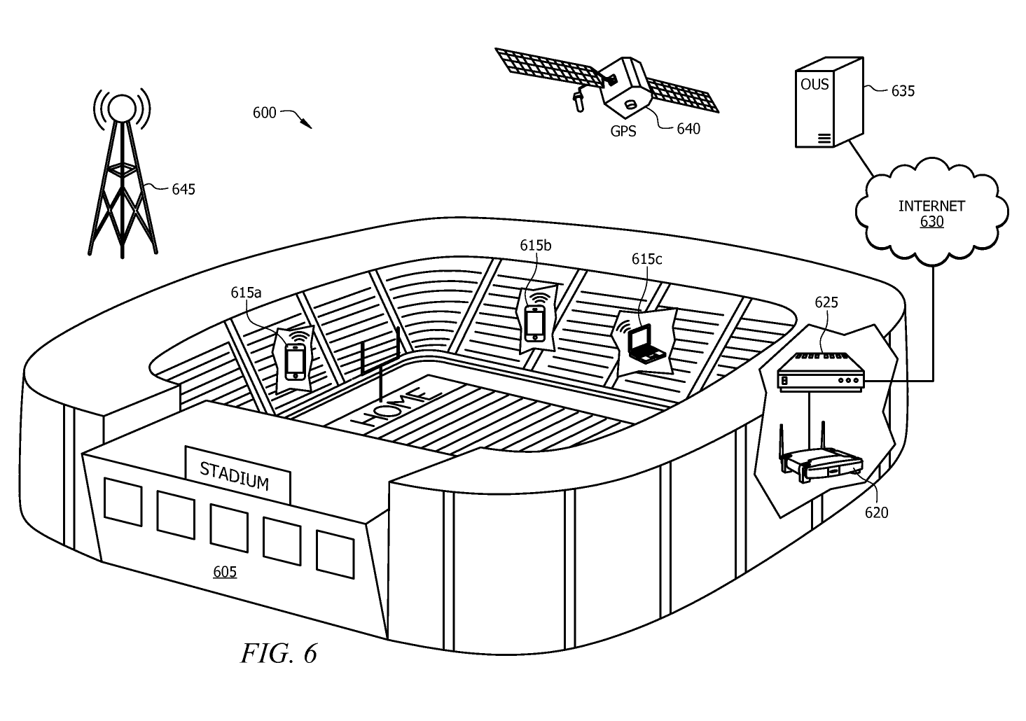

Turning now to FIG. 6, illustrated is an exemplary embodiment of a system 600 for providing access to one or more secure sites comprising information corresponding to one or more rules-based activities, where access is limited to within a predetermined distance of a location hosting the rules-based activity. Specifically, in this embodiment, the geographic location 605 is the actual location hosting the rules-based event, such as a stadium 605 hosting a football game. In other embodiments similar to the embodiments discussed with reference to FIG. 2, the stadium hosting the event 605 may actually be a plurality of stadiums hosting corresponding similar events.

In the embodiment illustrated in FIG. 6, attendees of the rules-based event again have computing devices 615a, 615b, 615c, which are configurable to access one or more secure sites provided and maintained by a host 635 via a computer network, such as the Internet 630. As in other embodiments of the disclosed principles discussed above, the geographic location of these computing devices 615a-c may be determined by any geolocation means, either now existing or later developed. For example, one or more GPS satellites 640 may be used in conjunction with GPS hardware/software on the computing devices 615a-c to determine with geographic location of one or more of the devices 615a-c. Alternatively, the geographic location of one or more of the computing devices 615a-c may be provided or confirmed using one or more cellular towers 645, as described above. Furthermore, applications on the computing devices 615a-c may facilitate the determination of geographic location, a local wireless network in the stadium 605 may detect when the mobile device is within a predetermined distance of such a wireless network, and RFID technology are all exemplary options for geolocation of user's devices 615a-c.

Moreover, the predetermined distance to the stadium 605 need not be limited to within the stadium 605 itself, and thus may include the grounds immediately surrounding the stadium. In such embodiments, attendees that are not actually in the stadium 605, such as “tailgaters” in the stadium parking lot, could also be determined to be within the predetermined distance of the stadium 605. However, as before, for computing devices 650 determined to not be within the predetermined distance of the established predetermined distance of the stadium 605, the disclosed principles would prevent these devices from gaining access to a secure site associated with a rules-based activity even if these devices obtained a connection to a computer network 630.

Also in accordance with the disclosed principles, the one or more secure sites provide users of the computing devices 615a-c determined to be within the predetermined distance of the stadium 605 access to interact with or receive information about the event being held at the stadium 605. For example, in accordance with the exemplary embodiments discussed above, the site(s) may be site(s) for wagering on events within such rules-based activities. The users of the computing devices 615a-c may access the secure site(s) through any means, such as wireless LAN via a wireless router 620, a cellular communications or data network via a cell tower 645, or even a hardwire connection to modem or other similar device configured to facilitate access to the computer network 630. However, as disclosed herein, even if a user of a computing device 605a-c has an access code or similar means for accessing a secure site related to the rules-based activity, access will not be permitted unless that user's device 605 is within the predetermined distance of the stadium 605.

As before, once the geographic location of attendees' computing devices 615a-c is confirmed to be within the predetermined distance of the stadium 605, access to the secure site(s) may require the use of a unique identifier by users attempting to access a secure site. The access code(s) may be provided by the stadium 605 as a benefit to those attending the event. Alternatively, access codes may be provided by the host 635 of the secure site(s), and those codes may again be based on each user's subscription with the host 635. Thus, when a user provides his unique identifier at the stadium 605, his access to select secure sites is granted in accordance with his subscription.

In related embodiments, multiple stadiums hosting multiple games simultaneously may be comprised within a system in accordance with the disclosed principles. In these embodiments, the attendees in any of the stadiums 605 may access one or more secure site(s) related to the events being simultaneously hosted at the stadiums. A separate access code may be required for each stadium, or a single access code for attendees at any of the stadiums may be provided. Alternatively, as before, access codes may be user-specific or even event-specific.

Also, as discussed above, users of the disclosed systems and methods may be situated to compete against one another. As such, the disclosed principles may provide a wagering system or access to one or more sites having a wagering system, that allows these users within the same stadium to not only wager on the rules-based events they are attending, but to perhaps compete against other users at the same stadium. Thus, an access code to the system or method provided as disclosed herein may be specific to that particular stadium to ensure users are only competing against other users at the same stadium. Additionally, multiple venues hosting corresponding events may also be linked for competition, such as in the embodiments discussed above with respect to multiple restaurants or bars broadcasting events within a rules-based activity. Thus, in embodiments with multiple stadiums, the collection of attending users participating at a given stadium may compete against the collection of participating users at another stadium. In such an example, access codes may be unique to each stadium to identify which users are at which venue. Alternatively, participating users at any stadium may compete among each other, regardless of location, within the same competition. In this respect, the competition would be limited to patrons of any of the collection of stadiums, regardless of location.

### Other Geographical Implementations

In addition to the geographic-based embodiments of the disclosed principles discussed with reference to the above figures, other implementations of systems and methods in accordance with the disclosed principles are also envisioned. For example, online sale of goods and/or services systems can include a mobile device physically located within a predetermined distance of a geographic location. In such embodiments, a service computer may provide the sale of goods and/or services via to the mobile device via a network where either restrictions exist and/or varying conditions have been set for such goods and/or services. Exemplary restrictions may include price or even the legality of the sale of such goods and/or services online based on the geographic location of the mobile device. An interface at the service computer may receive sale information on the order is being placed, and the service computer thus communicates sales related information to the mobile device as the order is being placed. The service computer would then verify compliance with conditions and restrictions of the sale based on the geographic location of the mobile device.

In another implementation, a targeted online marketing system can include a mobile device physically located in a certain geographic location, a service computer providing a subscription service to a subscriber's mobile device or computer via a network. The marketing may be targeted to, and even tailored to, the geographic location of the mobile device or subscriber computer. An interface at a service computer can receive marketing information as the subscriber is subscribing to the service, and the subscription service communicates marketing information to the mobile device or subscriber computer once the subscriber has subscribed to a service. The service computer could provide marketing information based on the geographic location of the subscriber computer, and thus allows a company to tailor marketing efforts to subscribers in a certain area or send location specific advertisements or via wireless networks based on the location of the mobile device or subscriber computer, thereby increasing efficiency and maximizing costs of marketing efforts.

Another exemplary embodiment may set limitations based on the geographic location of mobile device users attempting to wager on an event through a network. For example, the disclosed principles may limit access to only certain opportunities, such as wagering opportunities, based on the geographic location of user's computing device. For example, users in only certain locations may be permitted to participate in wagering on certain contests, perhaps local to their particular area. Similarly, users' locations may offer access to special wagering opportunities specific to their location(s), and thus may not be available to other users in non-qualifying locations.

In other implementations, access to online sweepstakes, contests, and other similar promotions may be limited based on the geographic location of the computing devices of users. Such embodiments may include receiving over a network a request to enter a promotion from a service computer, for example, once a user's device is determined to be within a certain geographic location. Such embodiments may further include retrieving information relevant to the geographic restrictions for the promotions, comparing the retrieved promotional information with a location-specific access code, and granting access to enter such promotions based on access rules and the comparison of the retrieved location of the computing device and the access code.

It is emphasized again that while only a limited number of exemplary embodiments have been introduced and discussed in the present disclosure, those skilled in the pertinent field(s) of art will understand that the broad scope of the disclosed principles encompass a far greater range of systems and methods that may be implemented with the disclosed principles.

### Mobile Device Software Application

As discuss above, the disclosed principles may be implemented in a number of ways, including the use of a mobile device software application installed on a user's mobile device. More specifically, such a mobile application would facilitate communication with a site, such as a wagering site as discussed above, using a user's mobile device though a connection to a computer network via wireless telephone or wireless computer network. In addition, the mobile application may be configured to provide the unique identifier discussed above. As before, such an access code may be user specific or location specific, and some embodiments, the application may be configured to acquire the access code, for example, when the mobile device is within a specific geographic location.

Among some of the features such a mobile application may include are the providing of “live updates” regarding rules-based activities, or contests/events, within those activities, and facilitating the determination of the geographic location of the mobile device. Live updates provided via a computer network may also be location specific, where updates are tied to the specific location of the mobile device. For example, in embodiments where the mobile device is at the location where the event in question is being held (see FIG. 6 above), the updates may be specific to that event or even to wagers placed by the user related to that specific event. Live updates may also be provided continuously until all pertinent rules-based activities or individual events have concluded.

Additionally, a mobile application in accordance with the disclosed principles may be used to detect and thus join events based on the combination of locational data and location-specific access codes at particular venues. Moreover, such venues may have internal or private networks linking their locations together, such as chains of sports bars, sporting venues, restaurants, etc. Still further, the mobile application may also work in n conjunction with location data to provide location-specific customer content, directed advertisements, or any other informational content.

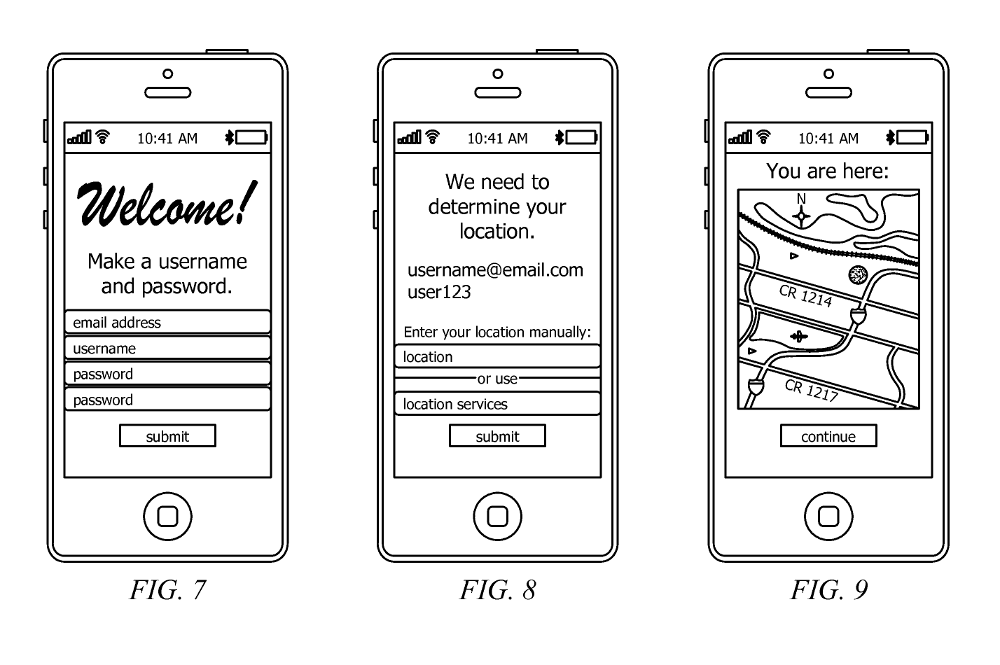

Looking now at FIG. 7, illustrated is a mobile device having an exemplary embodiment of a sign in or registration page of a mobile application developed and implemented in accordance with the disclosed principles. Such an exemplary page provides users with the ability to either login to their existing accounts, or create an account through registration, with a system established in accordance with the disclosed principles.

Display of such a registration/login screen may be the initial page displayed to a user of the mobile application upon starting the application. Alternatively, display of such a registration/login screen may be prompted by the entry of the mobile device within a predetermined distance of a given location. More specifically, any geolocation technique may be used to detect or confirm the location of the mobile device within a predetermined distance of a location participating in a system or method in accordance with the disclosed principles, and thus the application may automatically open when the device is within such a location.

Looking at FIG. 8, once a user has logged on to the disclosed system, the mobile application may display a page prompting a user to either manually input his location, e.g., by address, or to allow a geolocation means to determine his location. Again, any geolocation means may be employed with a mobile application in accordance with the disclosed principles. Once the geographic location of the user's mobile device is determined, a map indicating the geographic location of the mobile device running the application may be displayed to the user, as illustrated in FIG. 9. In addition, using the determined geographic location of the user's mobile device, the mobile application may inform the user of any events in his area provided in accordance with the disclosed principles. The available events may be illustrated to the user on a map, or may be provided via a list.

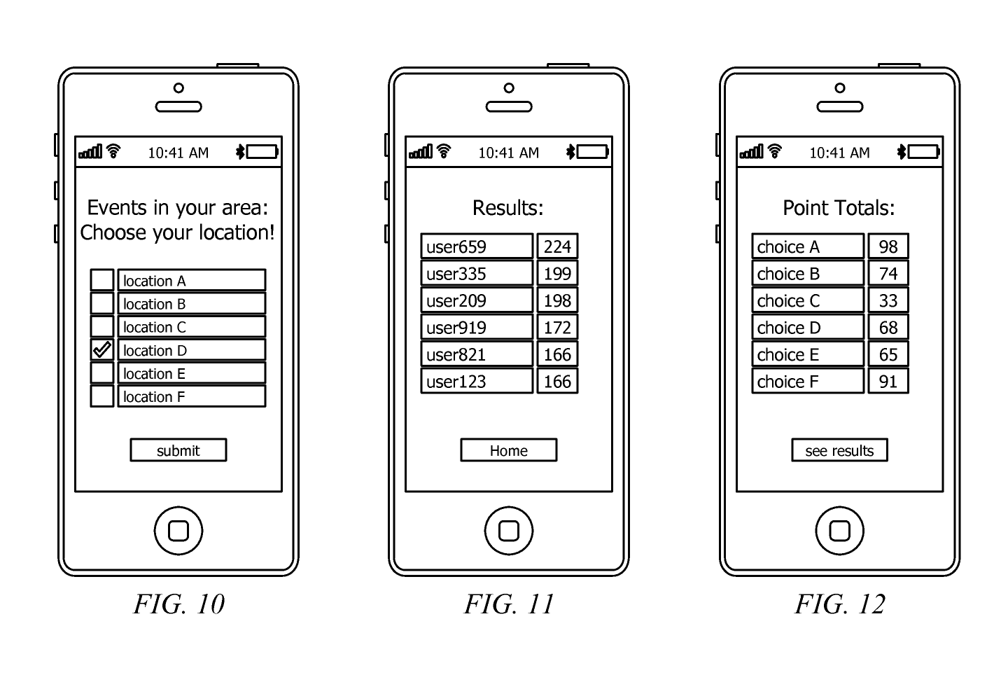

Similarly, as illustrated in FIG. 10, the user may be presented with a list of venues participating in one or more restricted events provided in accordance with the disclosed principles. Those events may be free events, or may require a fee to participate in. For example, if a chain of bars is providing a competition based on one or more rules-based activities in accordance with the principles discussed above, a list of participating locations may be presented to the user. The user may then select which location he is attending, and thus may participate in the competition from that location. As in other embodiments, the location of the user may be confirmed by any of a number of means, as discussed herein.

Once the user has selected a competition to participate in, by whatever means, the mobile device application may be further configure to provide scoring information to the user, as illustrated in FIG. 11. For example, if the user is competing against other users at one or more participating venues, such as the examples discussed above, current or ongoing results of one or more of the other participating users may be displayed via the application. Similarly, live scoring of individuals, collections of individuals, or teams within one or more contests in one or more rules-based activities may also be displayed to the user via that application. Once a part or all of a given competition is completed, the mobile application may also display final results to the user, as illustrated in FIG. 12. Of course, a mobile device application developed and implemented in accordance with the disclosed principles may also include and display different or additional pages and information to a user, and the disclosed principles are broad enough to encompass any such additional pages and information provided via an application.

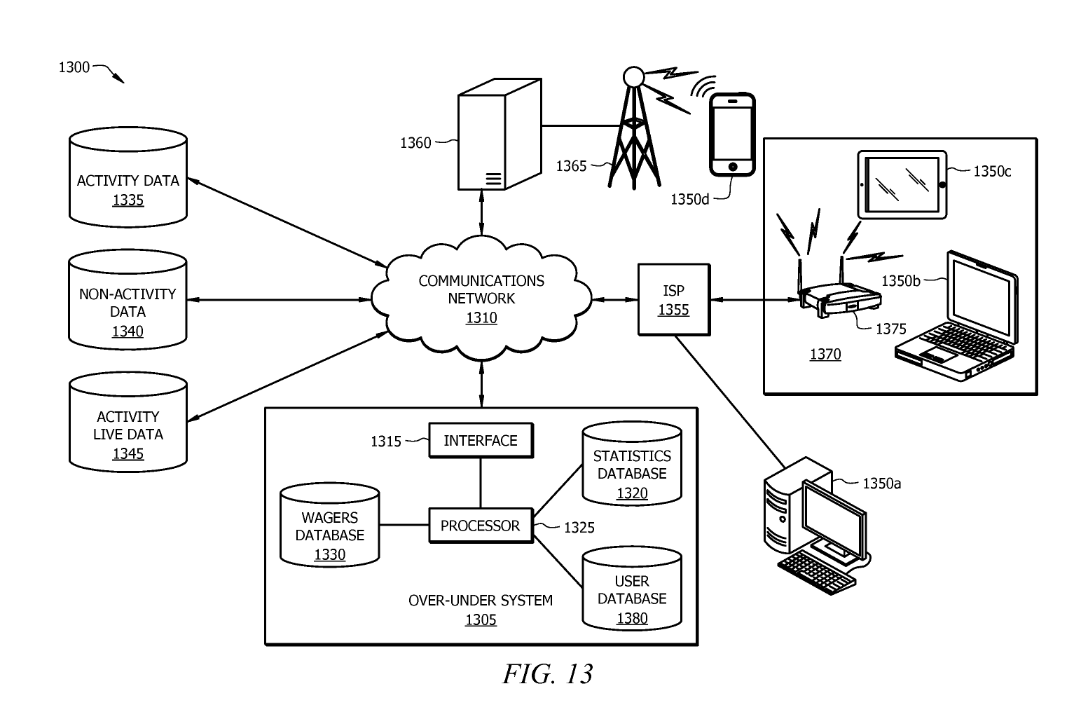

Turning now to FIG. 13, illustrated is a functional block diagram of one embodiment of a system 1300 for facilitating wagering in accordance with the disclosed principles. Within the system 1300 is an over-under wagering system 1305 configured to implement the over-under wagering technique discussed in detail above. Generally speaking, the over-under system 1305 is configured to obtain a variety of information from one or more sources having information regarding to individuals, collections of individuals, or teams participating in one or more rules-based activities, and to compile that information in order to project one or more performance benchmarks that may be achieved by an individual, collection of individuals, or a team in a contest within such a rules-based activity. Additionally, the over-under system 1305 is also configured to facilitate wagering from one or more users of the over-under system 1305, where the wagers are based on the over-under wagering technique disclosed herein.

The over-under system 1305 is connected to a communications network 1310, such as the Internet, in order to both receive and transmit information in accordance with the wagering technique disclosed herein. For example, the over-under system 1305 may comprise an interface 1315 to communicate such information to and from the communications network 1310. Additionally, the over-under system 1305 may include a database 1320 for storing and managing such information. The over-under system 1305 also includes a processor for compiling the information for use with the disclosed wagering technique. For example, the processor 1325 may be used to calculate the projected or forecasted performance benchmarks against which wagering is facilitated, as well as to process received wagers in view of actual performance benchmark results to determine winning and losing wagers, along with the amounts of payouts and amounts due (which may be in money, points, or other items) for those winning and losing wagers. A wager database 1330 may also be provided for storing and managing wagers placed on any of the rule-based activities and facilitated by the over-under system 1305. Those skilled in the art will understand that the over-under system 1305 may include different or additional components than those discussed herein, and the disclosed principles are broad enough to encompass any such variations.

Also connected to the communications network 1310 is a third-party activity data provider 1335. The activity data provider 1335 may provide any type of data, such as historical statistical data, associated to individuals, collections of individuals, or teams affiliated with a rules-based activity on which the over-under system 1305 may facilitate wagering. For example, in embodiments where the rules-based activity is professional football, such activity data provided to the over-under system 1305 may include any information regarding the prior performance of a player, collection of players, or team in professional football. That statistical information is provided to the over-under system 1305 for use in establishing the projected performance benchmarks to be the focus of the over-under wagering technique disclosed herein.

In addition to activity-based data, additional information that may affect a contest within the rules-based activity may also be provided by the non-activity data statistical provider 1340. For example, weather data related to the location of an event to be held may affect performances in that particular game, and thus that information may also be used by the over-under system 1305 when establishing a projected performance benchmark within that event. Of course, any such information that can affect performances within a given event or activity. Also connected to the communications network 1310 and configured to provide information to the over-under system 1305 is an activity live data provider 1345. As the name suggests, such a provider 1345 may be configured to feed information to the over-under system 1305 as events are taking place. Such live information may be used by the over-under system 1305 to determine winning and losing wagers, as well as for any other advantageous use in accordance with facilitating wagering as disclosed herein. It will be understood that although the data providers 1335, 1340, 1345 discussed with respect to FIG. 13 are illustrated as across the communications network 1310 from the over-under system 1305, the disclosed principles are also broad enough to encompass that the over-under system 1305 may itself be configured to derive some or all of the data used by the over-under system 1305.

The system 1300 illustrated in FIG. 13 also includes a plurality of users 1350a, 1350b, 1350c, 1350d, which may access the over-under system 1305 in order to participate in any type of wagering facilitated by the over-under system 1305. Those plurality of users 1350a-d may access the over-under system 1305 through a computing device, such as a desktop computer (1350a), a notebook computer (1350b), a tablet computer (1350c), or a mobile telephone 1350d). Of course, any type of communications means or device, computer-based or not and either now existing or later developed may be used to access and interact with the over-under system 1305.

For accessing the over-under system 1305, users may employ any of a number of means for communication with their computing device 1350a-d. For example, a desktop user 1350a may have employ an Internet Service Provider (ISP) 1355 to facilitate communication with the over-under system 1305. Other users, such as mobile device users 1350d, may communicate with the over-under system 1305 via a telecommunications server 1360, such as a cellular telephone data or voice network having one or more cellular towers 1365. Furthermore, for users that may be within a public or private establishment 1370, such as a bar, restaurant, club, or even a venue hosting a rules-based event, those users 1350b-c may communicate with the over-under system 1305 through a local wireless network, such as via a wireless router 1375. In accordance with embodiments discussed above, such establishments 1370 may be presenting one or more events pertaining to a rules based activity on which wagering is facilitated by the over-under system 1305, or such establishment(s) 1370 may be providing their own contest, which may be facilitated by the over-under system 1305.

Although in the illustrated embodiment, the telecommunications server and ISP communicate with the over-under system 1305 via the communications network 1310, in other embodiments, one or more such devices may communication directly with the over-under system 1305, thus not requiring the communications network 1310. As such, any means for communication with the over-under system 1305, either now existing or later developed, between the over-under system 1305 and ISPs, the telecommunications servers or networks, or any such device, is encompassed within the broad scope of the disclosed principles.

At the conclusion of a contest or event in a rules-based activity pertaining to the over-under system 1305, final live data may be received from the one or more live data providers 1345 of the system 1300. Alternatively, as mentioned above, the live data may be derived directly by the over-under system 1305. In either case, once all the final data is obtained by the over-under system 1310, the processor 1325 may then access the wager database 1330 to determine the winning and losing wagers. Such determinations may then be used to payout winning wagers, and collect from losing wagers, for example, by crediting to or debiting from a user database 1380. Of course, other means for paying or collecting on wagers facilitated by the over-under system 1310 may also be implemented, and the principles disclosed herein are broad enough to encompass any such means.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A method for providing access to, while in a predetermined geographic location, information corresponding to one or more rules-based activities via a private computer network, the method comprising:
providing a private computer network, comprising one or more computing devices executing operating firmware and software, at a predetermined geographic location;
confirming, with one or more devices associated with the private computer network, a geographic location of a computing device, associated with a member of the private computer network, within a predetermined distance of the geographic location of the network;
authenticating, with one or more devices associated with the private computer network, access to the private computer network by the member while the computing device is within the predetermined distance; and
upon successful authenticating, providing access to information regarding the one or more rules-based activities using the computing device via the private computer network only while the computing device remains within the predetermined distance.

2. A method in accordance with claim 1, wherein confirming the geographic location of the computing device comprises employing GPS technology, Assisted GPS technology (AGPS), Differential GPS (DGPS) technology, Time of Arrival (TOA) technology, Enhanced Time of Arrival (ETOA) technology, Maximum Likelihood (ML) and Least-Square (LS) location techniques, Angle of Arrival (AOA) location technique, Received Signal Strength (RSS) localization, Signal Fingerprinting, MAC address, LAN positioning system, Internet Protocol (IP) address, and RFID technology.

3. A method in accordance with claim 1, wherein the authenticating access comprises authenticating an access code provided by the member via the computing device while the computing device is within the predetermined distance.

4. A method in accordance with claim 3, wherein the access code corresponds to a specific rules-based activity among a plurality of rules-based activities, and wherein the permitting access to information further comprises permitting access to information regarding only the specific rules-based activity.

5. A method in accordance with claim 1, wherein the computing device comprises a mobile computing device.

6. A method in accordance with claim 5, wherein the mobile computing device comprises a mobile telephone.

7. A method in accordance with claim 5, wherein the mobile computing device comprises a software application configured to provide authentication data for the authenticating access.

8. A method in accordance with claim 5, wherein the mobile computing device comprises a software application configured to provide the geographic location of the computing device.

9. A method in accordance with claim 1, wherein the one or more rules-based activities comprises a sport, wherein the predetermined geographic location comprises a location of an event within the sport, and the predetermined distance comprises a venue hosting the sporting event.

10. A method in accordance with claim 1, wherein the predetermined geographic location comprises a public establishment broadcasting one or more contests within the one or more rules-based activities, and wherein the predetermined distance consists of only area substantially comprising the public establishment.

11. A method in accordance with claim 1, wherein the predetermined geographic location comprises a plurality of public establishments broadcasting one or more contests within the one or more rules-based activities, wherein the private computer network includes each of the plurality of public establishments, and wherein the predetermined distance consists of only areas substantially comprising each of the public establishments.

12. A method in accordance with claim 1, wherein the predetermined geographic location comprises a politically independent territory, and wherein the predetermined distance consists of only area substantially comprising the politically independent territory.

13. A method in accordance with claim 1, wherein the private computer network comprises a private wireless Local Area Network (LAN).

14. A method in accordance with claim 1, wherein the information regarding the one or more rules-based activities comprises data pertaining to performance of one or more participants in a contest within one of the one or more rules-based activities.

15. A method in accordance with claim 14, wherein the one or more rules-based activities comprises a sport, and wherein the data comprises a statistical performance of a team, a player, or a collection of players participating in a contest within the sport.

16. A method in accordance with claim 1, wherein the information regarding the one or more rules-based activities comprises wagering information by the member on a contests within the one or more rules-based activities via the computing device while the computing device is within the predetermined distance.

17. A method for providing access to, while in a predetermined geographic location, information corresponding to one or more rules-based activities via a private computer network, the method comprising:
providing a privately accessible computer system, comprising one or more computing devices executing operating firmware and software, configured to transmit and receive information regarding one or more rules-based activities;
confirming, with one or more devices in communication with the computer system, a geographic location of a computing device, associated with a user authorized to access the computer system, within a predetermined distance of a specific geographic location stored in, but distal from, the computer system;
authenticating, with one or more devices associated with the computer system, access to the computer system by the user while the computing device is within the predetermined distance; and
upon successful authenticating, transmitting and receiving the information regarding the one or more rules-based activities via the computing device only while the computing device remains within the predetermined distance.

18. A method in accordance with claim 17, wherein confirming the geographic location of the computing device comprises employing GPS technology, Assisted GPS technology (AGPS), Differential GPS (DGPS) technology, Time of Arrival (TOA) technology, Enhanced Time of Arrival (ETOA) technology, Maximum Likelihood (ML) and Least-Square (LS) location techniques, Angle of Arrival (AOA) location technique, Received Signal Strength (RSS) localization, Signal Fingerprinting, MAC address, LAN positioning system, Internet Protocol (IP) address, and RFID technology.

19. A method in accordance with claim 17, wherein the authenticating access comprises authenticating an access code provided by the user via the computing device while the computing device is within the predetermined distance.

20. A method in accordance with claim 19, wherein the access code corresponds to a specific rules-based activity among a plurality of rules-based activities, and wherein the permitting access to information further comprises permitting access to information regarding only the specific rules-based activity.

21. A method in accordance with claim 17, wherein the computing device comprises a mobile computing device.

22. A method in accordance with claim 21, wherein the mobile computing device comprises a mobile telephone.

23. A method in accordance with claim 21, wherein the mobile computing device comprises a software application configured to provide authentication data for the authenticating access.

24. A method in accordance with claim 21, wherein the mobile computing device comprises a software application configured to provide the geographic location of the computing device.

25. A method in accordance with claim 17, wherein the one or more rules-based activities comprises a sport, wherein the predetermined geographic location comprises a location of an event within the sport, and the predetermined distance comprises a venue hosting the sporting event.

26. A method in accordance with claim 17, wherein the predetermined geographic location comprises a public establishment broadcasting one or more contests within the one or more rules-based activities, and wherein the predetermined distance consists of only area substantially comprising the public establishment.

27. A method in accordance with claim 17, wherein the predetermined geographic location comprises a plurality of public establishments broadcasting one or more contests within the one or more rules-based activities, and wherein the predetermined distance consists of only areas substantially comprising each of the public establishments.

28. A method in accordance with claim 17, wherein the predetermined geographic location comprises a politically independent territory, and wherein the predetermined distance consists of only area substantially comprising the politically independent territory.

29. A method in accordance with claim 17, wherein the information regarding the one or more rules-based activities comprises data pertaining to performance of one or more participants in a contest within one of the one or more rules-based activities.

30. A method in accordance with claim 29, wherein the one or more rules-based activities comprises a sport, and wherein the data comprises a statistical performance of a team, a player, or a collection of players participating in a contest within the sport.

31. A method in accordance with claim 17, wherein the information regarding the one or more rules-based activities comprises wagering information by the member on a contests within the one or more rules-based activities via the computing device while the computing device is within the predetermined distance.

32. A method for facilitating wagering on contests within one or more rules-based activities, the method comprising:
acquiring, using a privately accessible computer system comprising one or more hardware devices running operating firmware and software, information regarding at least one of a team, an individual participant, or a collection of individual participants within a rules-based activity;
compiling, using one or more processors associated with the computer system, the information to generate a numerical model projecting a performance benchmark for at least one of a team, an individual participant, or a collection of individual participants participating in a contest within the rules-based activity;
providing, using an interface associated with the computer system, the projected performance benchmark to members authorized to access the computer system;
accepting, using the interface, wagers from the authorized members on whether an actual performance benchmark for the at least one of the team, the individual participant, or a collection of individual participants in the contest will be meet or fall below the projected performance benchmark; and
determining, with one or more processors associated with the computer network, winning and losing wagers based on the actual performance benchmark for the at least one of the team, the individual participant, or a collection of individual participants in the contest.

33. A method in accordance with claim 32, wherein the rules-based activity comprises a sport, the contest comprises a game within the sport, and the performance benchmark comprises a measurable statistical achievement during the game.

34. A method in accordance with claim 33, wherein the performance benchmark comprises a measurable statistical achievement for an individual player during the game.

35. A method in accordance with claim 33, wherein the acquired information comprises injury information regarding one or more of the at least one of the team, the individual participant, or the collection of individual participants participating in the sport.

36. A method in accordance with claim 33, wherein the sport comprises football, and wherein the team comprises a football team, the individual participant comprises a football player, and the collection of individual participants comprises one or more of an offensive unit, defensive unit, or special team of a football team.

37. A method in accordance with claim 32, wherein the method further comprises adjusting, by the one or more processors compiling the information, the projected performance benchmark prior to the contest based at least in part on the accepted wagers.

38. A method in accordance with claim 32, wherein the projected performance benchmark pertains to a performance benchmark at a period during the contest, and wherein the actual performance benchmark comprises the actual performance benchmark at the conclusion of that period during the contest.

39. A method in accordance with claim 32, wherein the acquired information comprises measurable performance statistics of one or more of a team, an individual participant, or a collection of individual participants based on participation of the team, the individual participant, or the collection of individual participants in one or more prior contests in a rules-based activity.

40. A method in accordance with claim 39, wherein compiling the information comprises generating a scoring model based on assigning one or more numeric values to one or more of said measurable performance statistics.

41. A method in accordance with claim 32, wherein the interface comprises a computer network site associated with the computer system and accessible by the authorized members.

42. A method in accordance with claim 32, wherein the performance benchmark comprises a score total for the contest computed from a numerical model based on the compiled information.

43. A method in accordance with claim 32, wherein determining winning wagers further comprises awarding scores to members having winning wagers.

44. A method in accordance with claim 32, further comprising determining, with the one or more processors determining winning and losing wagers, an additional amount for winning wagers based on a difference between the projected and actual performance benchmarks.

45. A method in accordance with claim 32, further comprising presenting, using the interface, to members having winning wagers an opportunity to purchase goods or services using wager winnings.

46. A method in accordance with claim 32, further comprising confirming, using hardware and software of a geographic location system in communication with the computer system, a geographic location of a member accessing the computer system.

47. A method in accordance with claim 46, wherein the geographic location system is selected from the group consisting of GPS technology, Assisted GPS technology (AGPS), Differential GPS (DGPS) technology, Time of Arrival (TOA) technology, Enhanced Time of Arrival (ETOA) technology, Maximum Likelihood (ML) and Least-Square (LS) location techniques, Angle of Arrival (AOA) location technique, Received Signal Strength (RSS) localization, Signal Fingerprinting, MAC address, LAN positioning system, Internet Protocol (IP) address, and RFID technology.

48. A method in accordance with claim 46, further comprising restricting the accepting of wagers to those members within a predetermined geographic location.

49. A method in accordance with claim 48, wherein the predetermined geographic location comprises an establishment presenting the contest to the authorized members.

50. A method in accordance with claim 49, wherein the geographic location system comprises a location-specific access code provided by authorized members while in the establishment.
